(19) United States
(12) Patent Application Publication
(10) Pub. No.: US 2011/0266180 A1
(43) Pub. Date: Nov. 3, 2011

(54) TUBULAR-BAG PACK FOR ARTICLES IN BAR FORM AND METHOD FOR PRODUCING A PACKAGING-MATERIAL WEB

(75) Inventors: Alfred Wipf, Jestetten (DE); Norbert Hoechst, Hilzingen (DE)

(73) Assignee: Robert Bosch GmbH, Stuttgart (DE)

(21) Appl. No.: 13/143,248

(22) PCT Filed: Dec. 3, 2009
(86) PCT No.: PCT/EP2009/066296

§ 371 Date: Jul. 5, 2011

(30) Foreign Application Priority Data
Jan. 20, 2009 (DE) 10 2009 000 331.2

(51) Int. Cl. B65D 85/20; B31B 1/26

(52) U.S. Cl. 206/446; 493/186; 493/231

(57) ABSTRACT

The invention relates to a tubular bag packaging (10) for tabular piece goods (14) made of a film-like packaging material (12) having a front packaging side (16), a rear packaging side (18) comprising a longitudinal seam (20), two transverse seams (22, 24) transverse to the longitudinal seam (20) disposed at a distance from each other, and at least one linear or lamellar separating area extending on the front packaging side (16) parallel to the longitudinal seam (20) as a tear open feature for opening the packaging. The packaging material (12) is separated in the separating area parallel to the longitudinal seam (20), disposed overlapping and releasably connected, forming at least one separable longitudinal seam (26) in the overlapping area.

### BACKGROUND OF THE INVENTION

The present invention relates to a tubular-bag pack for articles in bar form, in particular for bars of chocolate, made of a film-like packaging material, having a pack front side, a pack rear side that has a longitudinal sealing seam, two transverse sealing seams that are arranged in a spaced-apart manner transversely with respect to the longitudinal sealing seam, and at least one linear or strip-like separating region that extends parallel to the longitudinal sealing seam on the pack front side as an opening aid for opening the pack. Also in the context of the invention is a method suitable for producing a packaging material for the subsequent production of the tubular-bag pack.

DE 24 58 462 A1 discloses a tubular-bag pack for bars of chocolate that can be broken into rows. On the pack underside, a longitudinal sealing seam is arranged along a first predetermined breaking point of the bar of chocolate. The longitudinal sealing seam is separated by the bar of chocolate being broken along its predetermined breaking point, with the lever action employed in the breaking of the bar being used for overcoming the adhesive force of the seal, this being necessary for separating the longitudinal sealing seam and thus for opening the pack.

DE 26 58 631 A1 discloses a wrapper for bars of chocolate that are to be broken in the pack along a predetermined breaking point. A closure seam arranged on the pack underside is, in order to make it easier to separate said seam, provided with a cold adhesive which is applied only partially to that surface of the packaging material that forms the closure seam.

In the two abovementioned packs, it is disadvantageous that as a rule the unattractive underside of the product is exposed. Pulling apart the longitudinal sealing seam is moreover only possible when the product is used as a lever, this requiring that the product be broken.

DE 31 15 144 A1 discloses a film pack for bars of chocolate having a laterally arranged longitudinal sealing seam having a longitudinal notch as an opening aid. In order to open the pack, the longitudinal sealing seam, which protrudes from the pack in the form of a visually unattractive, wide tab, is torn away from the rest of the pack along the notch, which forms a predetermined breaking point.

WO 88/00562 A discloses a tubular-bag pack for bars of chocolate having a longitudinal sealing seam on the pack rear side. Lateral sealing seams are arranged in the packaging material in a manner extending on the pack front side in opposite edge regions parallel to the longitudinal sealing seam. Linear predetermined breaking points delimit a tear-open region. By way of an unsealed edge zone of a transverse sealing seam, the packaging material forming the pack front side can be grasped and, in order to open the pack, be pulled off the rest of the pack as a strip that extends across the width of the bar between the two predetermined breaking points. The opening of the pack front side reveals the attractive top side of the product, and it is easier to open the pack. However, a disadvantage of this pack is the high material consumption, since the two lateral sealing seams have to be folded over three times.

US-A-2005/276525 discloses a tubular-bag pack having a reclosing system in the form of a label which is incorporated into the packaging film and sealed in an overlapping manner. The attachment of a label with a small overlap results in only slightly increased material consumption. The labels can either already be incorporated in the film or only be attached at the packaging machine. Disadvantages with this pack are that the opening does not extend over the entire surface of the pack and so an article in bar form cannot be removed, and also the high costs of a prefabricated label.

### SUMMARY OF THE INVENTION

The object of the invention is to create a pack for articles in bar form which avoids the disadvantages mentioned in the prior art. In particular, it should be possible to produce the pack in a material-saving manner and it should be easy to open the pack over the entire width of the pack front side.

A further aim of the invention is to provide a method suitable for producing the pack.

The object is achieved according to the invention in that, in the case of a tubular-bag pack of the type mentioned at the beginning, the packaging material is separated parallel to the longitudinal sealing seam in the separating region, is arranged in an overlapping manner and is connected in a detachable manner in the overlapping region, forming at least one separable longitudinal seam.

The separable longitudinal seam may extend in an edge region or approximately centrally between the edge regions. It is preferable in this case for the separable longitudinal seam to be arranged in a manner spaced apart from a free longitudinal edge of the packaging material, forming a tear-open tab. The tear-open tab may be configured to form a lug-like grip tab by way of a loop-like cut.

In a further preferred tubular-bag pack, two separating regions, each having a separable longitudinal seam, are arranged in the two edge regions of the pack front side, forming an opening label that extends substantially over the entire width of the pack front side and can be detached from the pack. Expediently, in this case an unsealed edge zone is arranged in at least one transverse sealing seam, forming a tear-open tab.

In another preferred tubular-bag pack, two separating regions, each having a separable longitudinal seam, are arranged in the two edge regions of the pack front side, forming an opening label that extends substantially over the entire width of the pack front side and can be partially detached from the pack, wherein, in order to tear off the opening label from the rest of the pack, a weakening line is arranged, parallel to the transverse sealing seam, in the region of one of the transverse sealing seams in the packaging material.

A first method suitable for producing a tubular-bag pack according to the invention is characterized in that a strip-like packaging material web is deflected continuously about a first angle out of the plane of the packaging material web by lateral pulling-in of packaging material and at a distance is deflected in the opposite direction about a second angle into a plane parallel to the plane of the packaging material web, the packaging material web is severed in the first plane prior to deflection, forming a first packaging material web strip and at least one lateral packaging material web strip located on at least one side of the first packaging material web strip, the deflected parts of the at least one lateral packaging material web strip which are produced by the two deflections of the packaging material are transferred into the second plane, as a result of which the first packaging material web strip narrowly overlaps the at least one lateral packaging material web strip, and the packaging material web strips are connected in a separable manner in the overlapping region by way of an adhesive or a sealing layer, forming the separable longitudinal seams.

In a preferred embodiment, the packaging material web is severed in the first plane prior to deflection, forming a central packaging material web strip and two lateral packaging material web strips located on either side of the central packaging material web strip, and the deflected parts of the lateral packaging material web strips which are produced by the two deflections of the packaging material are transferred into the second plane, as a result of which the central packaging material web strip narrowly overlaps the lateral packaging material web strips.

A second method suitable for producing a tubular-bag pack according to the invention is characterized in that a strip-like packaging material web is deflected continuously by lateral pulling-in of packaging material to form at least one fold that projects perpendicularly out of the plane of the packaging material web, the packaging material web is severed in the fold, forming a first packaging material web strip and at least one lateral packaging material web strip located on at least one side of the first packaging material web strip, the parts of the fold which are produced from the packaging material by the severing of the fold and project out of the plane of the packaging material web are guided back into the plane of the packaging material web, as a result of which the first packaging material web strip narrowly overlaps the at least one lateral packaging material web strip, and the packaging material web strips are connected in a separable manner in the overlapping region by way of an adhesive or a sealing seam, forming the separable longitudinal seams.

Among the advantages achieved by the pack according to the invention are:

Easy to open pack for articles in bar form;

When the pack is opened, the attractive top side of the product is exposed;

The product is not damaged during opening;

The top side of the pack can be formed over the entire surface area (no disruptive label);

The material consumption is only slightly greater than in the case of a pack without an opening aid;

No complex material structures are necessary (the starting material can also be a monofilm);

Also suitable for “hot seal” materials (e.g. in order to create a “peel seal”);

The opening aid can be produced continuously in line, without an expensive film provided specially with the opening mechanism having to be used;

Use can be made of an existing standard tubular-bag machine, to which the module for producing the overlap seal is added;

Packs can be produced at high speed (cold seal);

It is not necessary to make any changes to the secondary packaging;

The opening tab or the opening mechanism does not have to be sought out;

The pack can be embodied such that it can be reclosed a number of times by way of a suitable sealing layer or an additional closure strip;

An opening tab can be incorporated;

The tubular-bag machine can produce packs with or without an opening aid by means of a simple conversion;

For small production batches, in which it is not worthwhile installing the module for producing the overlap seal on the packaging machine, instead of the method proposed it is possible to produce an identical pack by means of a roll of film having an already incorporated lap seal/opening aid.

### BRIEF DESCRIPTION OF THE DRAWINGS

Further advantages, features and details of the invention are given in the following description of preferred exemplary embodiments and by way of the drawing, which serves merely for illustration and is not to be interpreted in a limiting manner. The drawing schematically shows in:

FIG. 1 a cross section through a first embodiment of a tubular-bag pack;

FIG. 2 a cross section through a second embodiment of a tubular-bag pack;

FIG. 3 the plan view of the embodiment in FIG. 2 with an additional opening tab;

FIG. 4 a cross section through a third embodiment of a tubular-bag pack;

FIG. 5 a cross section through a fourth embodiment of a tubular-bag pack;

FIG. 6 the plan view of the embodiment in FIG. 5 with a partial label;

FIG. 7 a cross section through a fifth embodiment of a tubular-bag pack;

FIG. 8 a longitudinal section through the embodiment in FIG. 7;

FIG. 9 a first embodiment of a method for producing a packaging material web for producing tubular-bag packs;

FIG. 10 a second embodiment of a method for producing a packaging material web for producing tubular-bag packs (heat seal);

FIG. 11 a third embodiment of a method for producing a packaging material web for producing tubular-bag packs;

FIG. 12 a fourth embodiment of a method for producing a packaging material web for producing tubular-bag packs;

FIG. 13 a fifth embodiment of a method for producing a packaging material web for producing tubular-bag packs.

### DETAILED DESCRIPTION

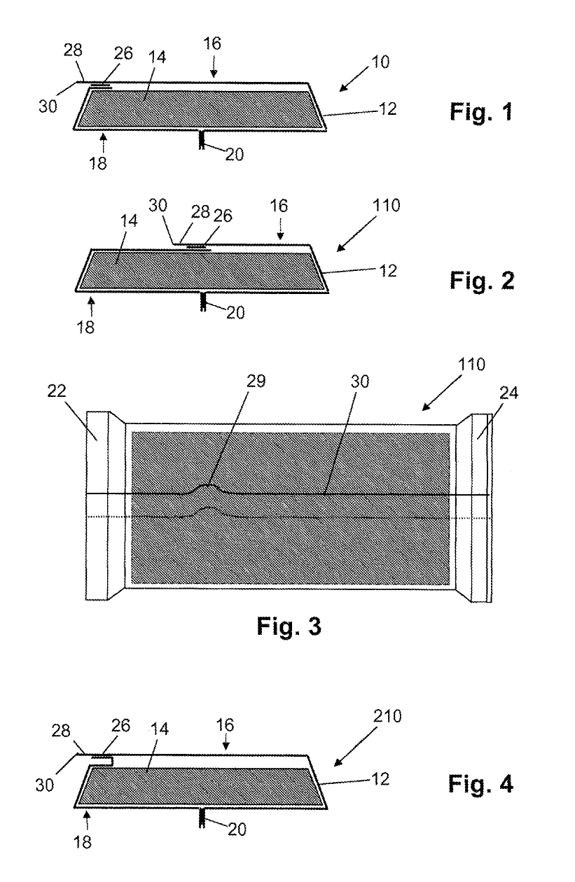

A tubular-bag pack 10 illustrated in FIG. 1 and made of a flexible, film-like packaging material 12 encloses an article in bar form 14, for example a bar of chocolate, and in this case forms a pack front side 16 and a pack rear side 18. Located on the pack rear side 18 is a longitudinal sealing seam 20 in the form of a fin, which is known under the technical term “fin seal”. Transversely to the longitudinal sealing seam 20, the tubular-bag pack, as shown in FIG. 4b, is closed at both ends in each case by a transverse sealing seam 22, 24. Arranged on the pack front side 16 and in a lateral edge region parallel to the longitudinal sealing seam 20 is an additional, separable longitudinal seam 26. The packaging material 12 is severed in this region and sealed in an overlapping manner. This overlapping seal is known under the technical term “lap seal”. The separable longitudinal seam 26 is arranged in a manner spaced apart from a free longitudinal edge 30 of the packaging material 12, forming a tear-open tab 28. The tear-open tab 28 extends over the entire length of the pack 10, so that when the pack 10 is torn open by pulling on the tear-open tab 28 and separating the separable longitudinal seam 26, the entire pack front side 16 is opened.

The tubular-bag pack 110 shown in FIG. 2 differs from the embodiment shown in FIG. 1 merely in that the separable longitudinal seam 26 with the tear-open tab 28 is arranged approximately in the longitudinal center of the pack front side 16. In this case, too, when the separable longitudinal seam 26 is separated by pulling on the tear-open tab 28, the pack is opened over the entire pack front side 16.

The tubular-bag pack 110 shown in FIG. 3 differs from the embodiment shown in FIG. 2 merely in that the tear-open tab 28 is configured to form a lug-like grip tab 29 by way of a loop-like cut.

The tubular-bag pack 210 shown in FIG. 4 differs from the embodiment shown in FIG. 1 merely in that the separable longitudinal seam 26 with the tear-open tab 28 is in the form of a fin seal. In this case, too, when the separable longitudinal seam 26 is separated by pulling on the tear-open tab 28, the pack is opened over the entire pack front side 16.

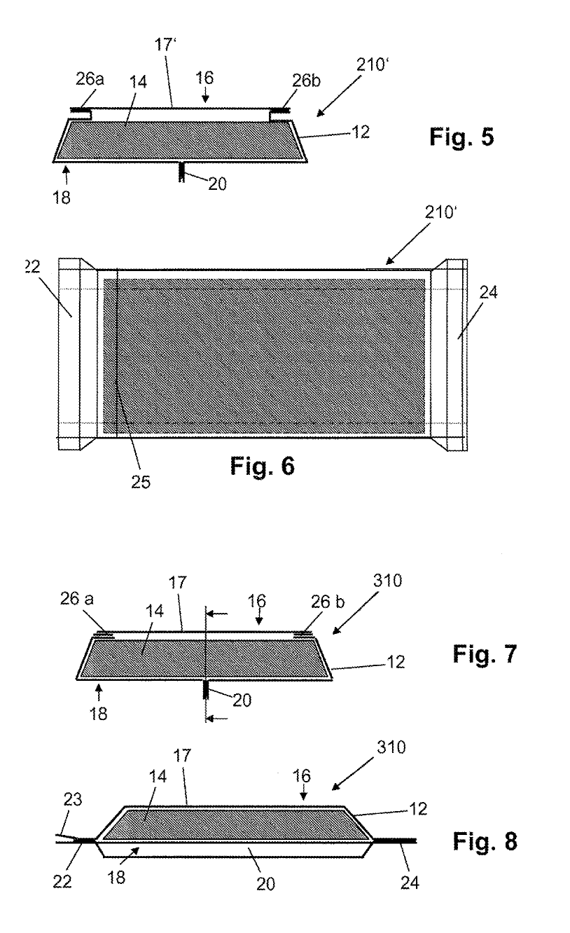

The tubular-bag pack 210′ shown in FIG. 5 differs from the embodiment shown in FIG. 4 in that two separating regions, each having a separable longitudinal seam 26a, 26b, are arranged in the two edge regions of the pack front side 16, forming an opening label 17′ that extends substantially over the entire width of the pack front side 16 and can be partially detached from the pack. As is apparent from FIG. 6, in order to tear off the opening label 17′ from the rest of the pack, with the two separable longitudinal seams 26a, 26b being separated, a weakening line 25 is arranged, parallel to the transverse sealing seam 22, in the region of one of the transverse sealing seams 22, 24 in the packaging material. At this weakening line 25, the pack can be torn and the partial opening label 17′ can be pulled off the rest of the pack.

In the embodiment of a tubular-bag pack 310 shown in FIG. 7, two separating regions, each having a separable longitudinal seam 26a, 26b, are arranged in the two edge regions of the pack front side 16, forming an opening label 17 that extends substantially over the entire width of the pack front side 16 and can be detached from the pack. In order to pull off the opening label 17 from the rest of the pack, with the two separable longitudinal seams 26a, 26b being separated, an unsealed edge region is arranged at one of the transverse sealing seams 22, 24, forming a tear-open tab 23 (FIG. 8).

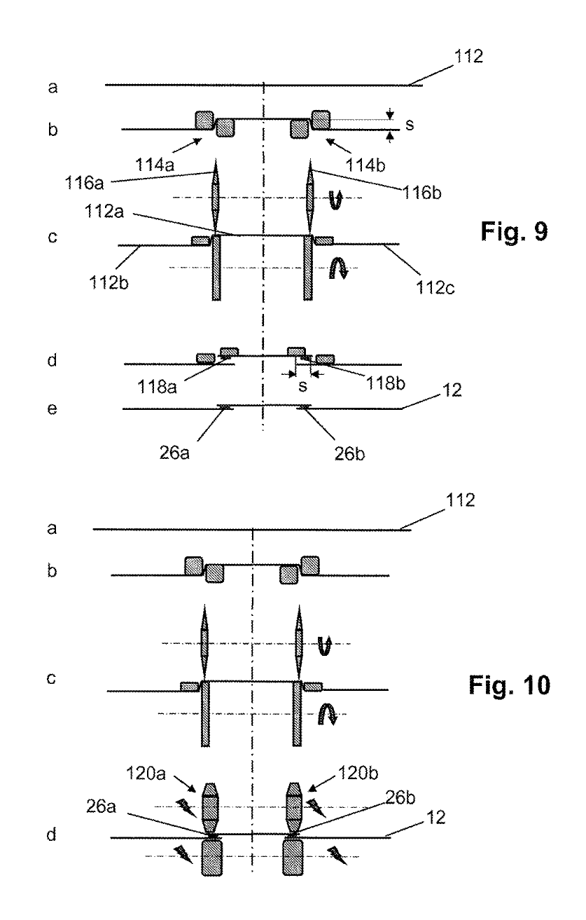

In a method, illustrated in five steps a-e in FIG. 9, for the continuous production of a packaging material 12 having two additional separable longitudinal seams 26a, 26b for producing a tubular-bag pack 310 according to FIG. 7, a planar flexible packaging material web 112 is unrolled from a feed roll (not illustrated) (step a) and, in a folding arrangement consisting for example of two pairs of rolls 114a, 114b, is continuously deflected about a first angle out of a first plane by lateral pulling-in of packaging material and at a distance s from the first plane is deflected in the opposite direction about a second angle into a second plane parallel to the first plane (step b). The packaging material web 112 is severed in the first plane upstream of the deflection point, for example by means of cutting wheels 116a, 116b, forming a central packaging material web strip 112a and two lateral packaging material web strips 112b, 112c located on either side of the central packaging material web strip 112a (step c). On account of the stiffness of the film-like packaging material, the deflected parts of the lateral packaging material web strips 112b, which parts correspond substantially to the distance s between the planes that is produced by the two deflections of the packaging material, spring into the second plane, as a result of which the central packaging material web strip 112a narrowly overlaps the lateral packaging material web strips 112b (step d). By applying pressure to the packaging material web strips 112a, 112b in the overlap region, said strips are separably sealed by way of strips of cold adhesive 118a, 118b applied to one side, forming the separable longitudinal seams 26a, 26b. The strips of cold adhesive 118a, 118b can already be present on the packaging material web 112 that is available as rolled material, or can be applied to the packaging material web 112 before the latter, which may already have been deflected, is severed.

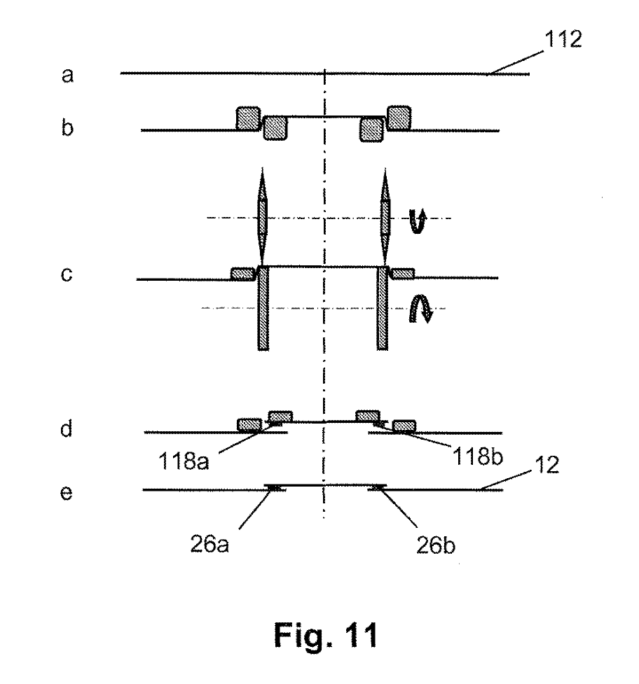

The method, illustrated in four steps a-d in FIG. 10, for the continuous production of a packaging material 12 having two additional separable longitudinal seams 26a, 26b for producing a tubular-bag pack 310 according to FIG. 7 differs from the method shown in FIG. 9 merely by the type of application of the sealing medium. In this case, this is already present as a heat seal layer over the entire surface area on one side of the pack. Sealing takes place by means of heatable sealing tools, e.g. in the form of pairs of sealing rolls 120a, 120b (step d), with attention being paid to peelable sealing.

The method, illustrated in five steps a-e in FIG. 11, for the continuous production of a packaging material 12 having two additional separable longitudinal seams 26a, 26b for producing a tubular-bag pack 310 according to FIG. 7 differs from the method shown in FIG. 9 likewise merely by the type of application of the sealing medium. In this case, this is sprayed on in the form of hotmelt strips (step d) following the cutting process (step c). By applying pressure to the packaging material web strips 112a, 112b in the overlap region, said strips are separably sealed by way of the hotmelt strips 118a, 118b applied to one side, forming the separable longitudinal seams 26a, 26b.

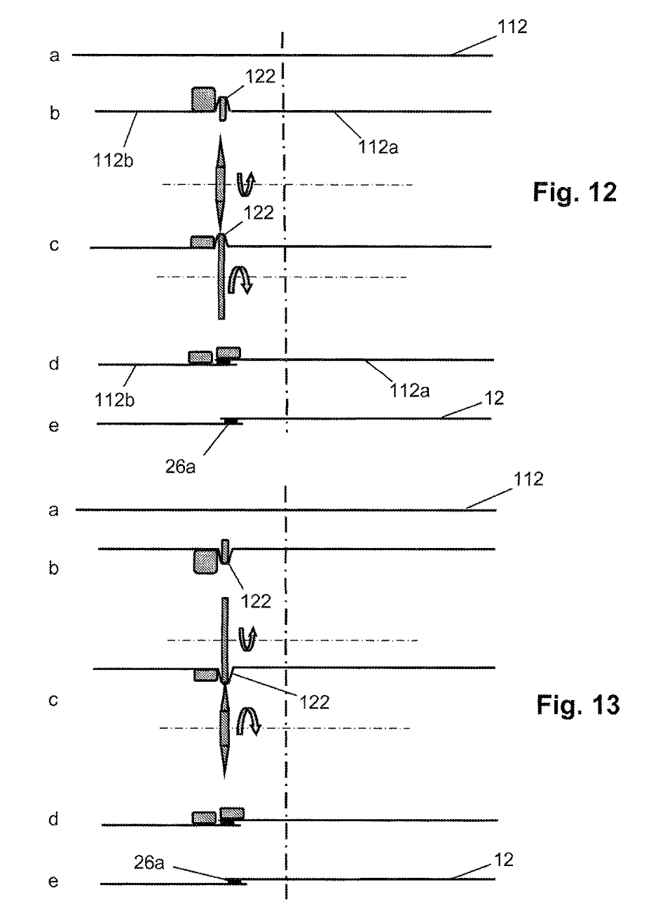

The method, illustrated in five steps a-e in FIGS. 12 and 13, for the continuous production of a packaging material 12 having an additional separable longitudinal seam 26a for producing a tubular-bag pack 10 according to FIG. 1 differs from the method shown in FIG. 11 in that a strip-like packaging material web 112 is deflected continuously by lateral pulling-in of packaging material to form a fold 122 that projects perpendicularly out of the plane of the packaging material web (step b) and the packaging material web 112 is severed in the fold 122, forming a first packaging material web strip 112a and a lateral packaging material web strip 112b located on one side of the first packaging material web strip 112a (step c). The parts of the fold 122 which are produced from the packaging material by the severing of the fold 122 and project out of the plane of the packaging material web are guided back into the plane of the packaging material web, as a result of which the first packaging material web strip 112a narrowly overlaps the lateral packaging material web strip 112b. The methods according to FIGS. 12 and 13 differ merely by the side of the packaging material web on which the fold 122 is formed and severed.

Advantageously, the seams, in particular also the longitudinal seam (a seal) can be sealed by means of ultrasound. This can firstly reduce the material consumption, in that the longitudinal seam is configured to be narrower. Secondly, the application of heat to the product and also the film is reduced, thereby lowering the risk of the film warping. The design is further improved in that the longitudinal seam not required for opening is less visually apparent. The other seams, too, can be sealed by means of ultrasound.

1. A tubular-bag pack (10, 110, 210, 310) for articles (14) in bar form, the tubular-bag pack (10, 110, 210, 310) made of a film-like packaging material (12), having a pack front side (16), a pack rear side (18) that has a longitudinal sealing seam (20), two transverse sealing seams (22, 24) that are arranged in a spaced-apart manner transversely with respect to the longitudinal sealing seam (20), and at least one separating region that extends parallel to the longitudinal sealing seam (20) on the pack front side (16) as a tear-open aid for opening the pack, characterized in that the packaging material (12) is separated parallel to the longitudinal sealing seam (20) in the separating region, is arranged in an overlapping manner and is connected in a detachable manner in the overlapping region, forming at least one separable longitudinal seam (26, 26a, 26b).

2. The tubular-bag pack as claimed in claim 1, characterized in that the separable longitudinal seam (26) is arranged in a manner spaced apart from a free longitudinal edge (30) of the packaging material (12), forming a tear-open tab (28).

3. The tubular-bag pack as claimed in claim 2, characterized in that the tear-open tab (28) is configured to form a lug-like grip tab (29) by way of a loop-like cut.

4. The tubular-bag pack as claimed in claim 1, characterized in that the separable longitudinal seam (26) extends in an edge region of the pack front side (16).

5. The tubular-bag pack as claimed in claim 1, characterized in that two separating regions, each having a separable longitudinal seam (26a, 26b), are arranged in two edge regions of the pack front side (16), forming an opening label (17) that extends substantially over an entire width of the pack front side (16) and can be detached from the pack.

6. The tubular-bag pack as claimed in claim 5, characterized in that an unsealed edge zone is arranged at least one transverse sealing seam (22), forming a tear-open tab (23).

7. The tubular-bag pack as claimed in claim 1, characterized in that two separating regions, each having a separable longitudinal seam (26a, 26b), are arranged in two edge regions of the pack front side (16), forming an opening label (17′) that extends substantially over an entire width of the pack front side (16) and can be partially detached from the pack, wherein, in order to tear off the opening label (17′) from the rest of the pack, a weakening line (25) is arranged, parallel to the transverse sealing seams (22, 24), in the region of one of the transverse sealing seams (22, 24) in the packaging material.

8. A method for producing a packaging material web for producing tubular-bag packs, the method characterized in that
a strip-like packaging material web (112) is deflected continuously about a first angle out of a first plane of the packaging material web by lateral pulling-in of packaging material and at a distance (s) is deflected in an opposite direction about a second angle into a second plane parallel to the first plane of the packaging material web,
the packaging material web (112) is severed in the first plane prior to deflection, forming a first packaging material web strip (112a) and at least one lateral packaging material web strip (112b, 112c) located on at least one side of the first packaging material web strip (112a),
the deflected parts of the at least one lateral packaging material web strip (112b, 112c) which are produced by the two deflections of the packaging material are transferred into the second plane, as a result of which the first packaging material web strip (112a) narrowly overlaps the at least one lateral packaging material web strip (112b, 112c), and
the packaging material web strips (112a, 112b, 112c) are connected in a separable manner in an overlapping region by way of a sealing seam, forming separable longitudinal seams (26a, 26b).

9. The method as claimed in claim 8, characterized in that
the packaging material web (112) is severed in the first plane prior to deflection, forming a central packaging material web strip (112a) and two lateral packaging material web strips (112b, 112c) located on either side of the central packaging material web strip (112a), and
the deflected parts of the lateral packaging material web strips (112b, 112c) which are produced by the two deflections of the packaging material are transferred into the second plane, as a result of which the central packaging material web strip (112a) narrowly overlaps the lateral packaging material web strips (112b, 112c).

10. A method for producing a packaging material web for producing tubular-bag packs, the method characterized in that
a strip-like packaging material web (112) is deflected continuously by lateral pulling-in of packaging material to form at least one fold that projects perpendicularly out of a plane of the packaging material web,
the packaging material web (112) is severed in the at least one fold, forming a first packaging material web strip (112a) and at least one lateral packaging material web strip (112b), located on at least one side of the first packaging material web strip (112a),
the parts of the at least one fold which are produced from the packaging material by the severing of the at least one fold and project out of the plane of the packaging material web are guided back into the plane of the packaging material web, as a result of which the first packaging material web strip (112a) narrowly overlaps the at least one lateral packaging material web strip (112b), and
the packaging material web strips (112a, 112b) are connected in a separable manner in the overlapping region by way of a sealing layer, forming separable longitudinal seams (26a, 26b).

11. The method as claimed in claim 8, characterized in that the sealing seam includes an adhesive seam.

12. The method as claimed in claim 10, characterized in that the sealing layer includes an adhesive layer.

13. The tubular-bag pack as claimed in claim 1, characterized in that the separating region is at least one of linear and strip-like.

14. The tubular-bag pack as claimed in claim 1, characterized in that the separable longitudinal seam (26) extends approximately centrally between edge regions of the pack front side (16).
